(19) United States
(12) Patent Application Publication
(10) Pub. No.: US 2013/0088323 A1
(43) Pub. Date: Apr. 11, 2013

(54) System and Method for Shipping Distribution and Pickup

(71) Applicant: Gerald P. Ryan, Geneva, IL (US)

(72) Inventor: Gerald P. Ryan, Geneva, IL (US)

(21) Appl. No.: 13/632,052

(22) Filed: Sep. 30, 2012

Related U.S. Application Data
(60) Provisional application No. 61/544,931, filed on Oct. 7, 2011.

(51) Int. Cl. G06F 19/00; G05B 19/00

(52) U.S. Cl. 340/5.7; 235/375

(57) ABSTRACT

A shipping and distribution system with remote holding pods where a shipper can safely leave a package, and the recipient of the package can pick it up. The system controls the package from the time the shipper leaves it at the pod until the package owner or recipient or authorized party retrieves it. A system controller with an online interface allocates the temporary storage resources to shipping/receiving parties. Secure access codes are provided to both the shipper and the recipient. The secure storage area at the pod can contain a contents sensor that can notify the receiver when the package is deposited and the sender when the package is retrieved.

This application is related to, and claims priority to, U.S. Provisional patent application No. 61/544,931 filed Oct. 7, 2011. Application 61/544,931 is hereby incorporated by reference in its entirety.

### BACKGROUND

1. Field of the Invention

The present invention relates generally to shipping and more particularly to a shipping distribution and pickup system and method.

2. Description of the Prior Art

E-commerce is becoming well-known and frequently used. A purchaser browses a website and finds products to buy. The products are purchased by clicking on them and placing them in a virtual shopping basket. As the order is being closed, the purchaser is usually given several shipping options. Each of these options usually includes sending the item to the person's home or business. Unfortunately, shippers are notorious for simply leaving packages on doorsteps or with neighbors. It is not uncommon to have packages damaged by rain, stolen or misplaced this way. Sometimes packages are left on doorsteps or behind doors and are not discovered by the owner for several days. In addition, packages left with neighbors or at a business may compromise the purchaser's privacy.

It would be especially advantageous to have a system and method where a purchaser could have a package shipped to a holding pod that could be accessible only to that purchaser for the single purpose of picking up his or her package rather than to a residence or business.

Such a system should be first accessible over the Internet by the merchant to ship, and then by the purchaser to pick up the item. The system should have built-in security so that only the correct party can retrieve the item.

Such a system could also be used by any two parties wishing to exchange goods. This could include people not necessarily involved in commerce, but those wishing to exchange goods where each has schedules which preclude a personal meeting. Another reason for this intermediate method of shipment for is that is allows for anonymity between the shipper and receiver.

### SUMMARY OF THE INVENTION

The present invention relates to a shipping and distribution system and method that includes remote holding pods located in neighborhoods or near businesses where a shipper can safely leave a package, and the owner or recipient of the package can pick it up. The system controls the package from the time the shipper leaves it at the pod until the package owner or recipient or authorized party retrieves it. A system controller with an online interface allocates the temporary storage resources to shipping/receiving parties. The shipping company, or the individual selecting this shipping arrangement, typically does so for convenience, speed and security. The system is convenient because the receiver does not have to be present at the time of delivery. Deliveries are faster because the delivery person never needs to wait for a signature, and may be dropping off a number of packages at one pod location. Finally, the present invention provides security, because the packages are never dropped off at an unsecure location (such as the doorstep of a household).

### DESCRIPTION OF THE FIGURES

Several drawings are now presented to illustrate features of the present invention:

FIG. 1 is a system overview of an embodiment of the present invention.

FIG. 2 is a block diagram of a remote pod embodiment.

Several illustrations have been presented to aid in understanding the present invention. The scope of the present invention is not limited to what is shown in the figures.

### DETAILED DESCRIPTION OF THE PREFERRED EMBODIMENT

The present invention includes a number of remote pods where shippers can safely leave packages and package owners or other authorized parties can retrieve them. The present invention contains at least three important parts: remotely located holding pods, a shipping system controller with a Web-based user interface, and communication backhaul and security.

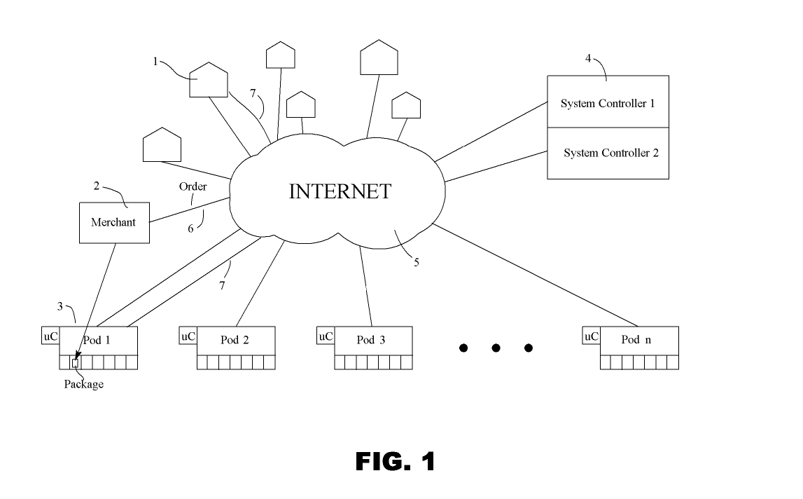

Turning to FIG. 1, an overview of the system and method of the present invention can be seen. Houses (or businesses) 1 and merchants 2 are connected to the internet 5. A number of pods 3 are place remotely in locations convenient to deliver and pickup packages. A system controller 4 communicates with shippers and with the pods 3 over via the Internet. A particular purchaser at home or at a business 1 places an order 6 over the Internet. The merchant 2 receives and processes the order. As a shipping option, the merchant can ship the package to the purchaser with delivery at a particular remote pod 3. The system sends a notification 7 when the package is available at the pod along with an access code. The purchaser can then pick up the package within a reasonable time. The present invention does not have to be used just for purchases; any party desiring to ship a package to any other party may use the system via the Internet.

### Remotely Located Holding Pods

As previously stated, a number of remotely located holding pods can be located in a convenient delivery location. A remote pod typically includes a group of locked boxes controlled by a local processing unit with a kiosk interface. There can be any number of boxes per pod. The boxes within the pod can be a multiple (fixed) sizes, or there can be differently sized boxes. The boxes can be uniquely numbered within a pod, and the pods can be uniquely numbered within the shipping system. Each box has its own electronically controlled lock that is independent of the other boxes within the pod. The local processing unit locks and unlocks the boxes and reports receiving and pickup status to the shipping system controller. Because the holding pods require power to function, they may be equipped with an optional battery backup. Each Holding Pod also has the option of having various security measures. Security measures may include but are not limited to cameras (with remote feed), lighting, physical security (in the form of lock, gates, etc.).

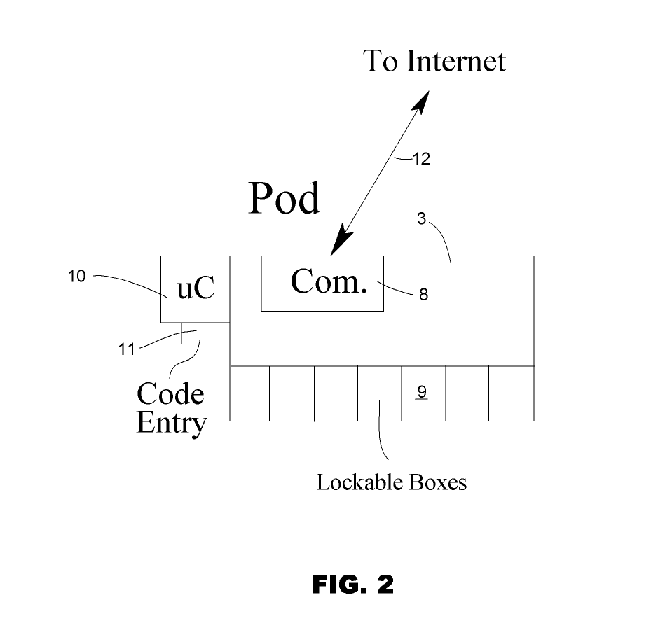

FIG. 2 shows a block diagram of a remote pod. Each pod 3 contains a controller 10 and a communications module 8 that allows communication with a network such as the Internet. Each pod 3 also contains a number of locked boxes or lockable storage areas 9. A kiosk interface 11 allows code entry and access to particular boxes 9 by either the shipper making a delivery or by the owner picking up a package.

### Delivery and Pickup at the Pod

Individuals, usually shippers wishing to make a delivery to one or more boxes within the pod first log into the local kiosk. Local login can be in the form of an electronic ID wand, a bar code reader, a card reader with an access PIN or a log in prompt requiring a user name and password. Once logged into the system, the user selects the system assigned box for drop off, and the box is unlocked. Alternatively, a code can be given which must be entered to open the box—this method is preferred for larger pod locations. If the box code method is used, then each box can also be equipped with an RFID (or other) reader that can be activated by the deliverer using his specific ID wand (which can be enabled in advance by the system, thereby relieving the need for the deliverer to log in at all to the local Kiosk. This is the preferred method for the larger package deliverers like FedEx, UPS, USPS, etc.). The item(s) is placed in the box, and the user closes the door. The box relocks as the door is closed. The user then delivers to other system assigned boxes if applicable. When all deliveries are complete, the delivery user logs off the local unit. At this point, the shipment can be considered complete, and the pod controller notifies the shipping system controller that this specific delivery has been made. Note, prior to departure, the purchaser may be notified (via the kiosk or by the system controller) that a pickup is available at that site.

Upon notification from the shipping system controller that an item is ready for pickup, the person wishing to make a pickup goes to the pod location or sends another authorized party. As in the delivery process, the person making the pickup first logs into the remote pod kiosk via an electronic ID wand, a bar code reader, a card reader with an access PIN or a login prompt requiring a user name and password. Usually, the recipient, either at shipping time, or upon being notified of the delivery receives an access code that allows them access to the item. The recipient selects the item for pickup, and the system assigned box within the pod is opened. Optionally, the user can receive a box code from the local pod controller, and the user must punch in that code on a key pad located on the individual lock box itself. Another option is an RFID reader (or IR receiver) on the box that accepts or reads the code from a wand. This local code delivery option is particularly useful in large pod locations where the number of boxes in the delivery pod could be large, maybe in the hundreds. The user removes the items and shuts the box door if the item is acceptable (or the door automatically closes after time out).

In the system of the present invention, the user can identify an incorrect shipment and immediately initiate a return if the item is rejected. Depending on the shipping agreement, the user may not incur a return shipping fee. As an option, the box itself can have a weight sensor that can determine if an item has been removed and further determine an approximate weight of the item. The user can make additional pickups (or deliveries), and when all of the pickups are complete, the user typically logs off the system, and the pod controller notifies the shipping system controller that the pickup has been made.

Shipping System Controller with Web Based User Interface

The shipping system controller 4 typically maintains a database which keeps track of parcel delivery, pickup status and pod box availability. A web-based interface between the system controller database and the users of the system can allow merchants or shippers to specify specific pod locations for delivery, and can allow purchasers to know when an order has arrived and to receive an box number and access code or barcode.

There are two major ways to access the system. Users can go directly to the distribution system website, or users can access the web interface via a third party website (such as an online merchant or a shipping carrier). Direct access would be for individual or small business shipping. Third party access would most likely occur when the purchaser of an item selects the shipping distribution system as the method for delivery.

The system controller normally issues notifications when items are confirmed as delivered or received. These notifications are selectable by the end users to be via email, instant message, tweet, facebook post, automated phone message or by any other technology. Alerts can be configured by the user to be repeating at set intervals, or provided only once.

For the reliability, the shipping controller is preferred be two times redundant including an active and a standby controller. The standby controller maintains a mirror image of the shipping database that the active controller is using. Should the active controller malfunction, the redundant controller automatically takes over, and at the same time, initiates communication with the parties responsible for the maintenance of the system so that the malfunctioning controller can be replaced or repaired. The system controller typically should have battery backup to provide service in the event of a power outage.

### Communication Backhaul and Security

Critical to the shipping distribution system of the present invention is the communication link between the remote pods and the shipping system controller. The communication system will in the preferred embodiment make use of the Internet. The link to and from the system controller, remote pods and the Internet will be via a wired or wireless connection (preferably both for redundancy).

In addition to redundancy, the system must be secure. It is preferred that an encrypted virtual private link be established between the system controller and each pod controller. This can be a IPsec tunnel, an https link or any other private encrypted link. Such a link makes eavesdropping or false data injection extremely difficult. In addition to communications security, there should be security between the users and the system. The preferred method is to use an https connection when the purchaser (or pickup party) is given a particular access code or access barcode. The preferred method is to provide a one or two dimensional barcode or a QR code containing a randomly generated access code. The same barcode can be sent over the secure link to the proper pod controller. This code can indicate the pod identifier and the box identifier. Thus, when the recipient arrives for pickup, the same barcode can be scanned at the pod. A further password sent to the user over a different route (such as by Email) may be used for additional security. The recipient may receive the bar code or Quick Response code (QR code) on their cellular telephone and display that at the pod to gain access into the locked storage area.

### Overall Method

The present invention presents a method where a merchant or other person can ship, and a user can receive, a parcel at a remote locked pod box. As shown in FIG. 1, a user can place an order with a merchant. While selecting shipping, the user can indicate the location of a pod where he or she would like delivery (or the system can suggest one nearby). The purchaser pays for the product and shipping in the normal manner. Part of the shipping charge goes to the shipping system manager who manages the particular pod. A major shipper such as FedEx, UPS or the USPS may also allow the shipper of a package to select and pay for the use of a pod.

When the shipper arrives at the pod with the package, the shipper enters data about the shipment which may include an access code into the pod controller either using an entry device such as a hand-held communication device, or they enter data into the pod kiosk. The pod controller than assigns and opens a particular box. The package is placed into the box, and the shipping system sends a notification to the merchant and to the purchaser that delivery has been made. As previously stated, the purchaser may also be given an access code or barcode to open the particular box. That access code can optionally be received and stored on the purchaser's smartphone.

When the recipient arrives at the pod, they enter the code or barcode, either by keying it in, having it scanned (barcode), or by communicating it directly from their smartphone to the kiosk via the Internet via a secure communication path. When the pod controller receives the proper code or barcode, it opens the correct box. The box can also be equipped with and infrared (IR) reader, RFID reader, or any other form of touch-less interface. When the package is removed (which can be detected by a sensor, or by weight, or when the box is re-closed, the pod controller sends a notification to the system controller and internally marks that box as free. In the case where the recipient rejects the item, the item is left in the box, and the recipient keys that information into the pod kiosk. The pod controller sends a rejection notification to the shipping controller which forwards that to both the shipper and the merchant. The merchant or the shipper can then arrange to have the item picked up for return.

For security, the access code entered by the shipper making the delivery can be different than the access code entered by the recipient for pickup. Also optionally, once the box is opened and re-locked under the first access code, the system can prevent that box from being re-opened under that first code, but rather allow it to only be opened the second time under the recipient's access code. The box can also have a time-out where if the item is not picked up by a certain date or time, the box will not open. In this case, the receiver and/or the shipper can be notified. The owner of the storage pod can also be notified so that the item does not occupy the box indefinitely.

Several descriptions and illustrations have been provided to aid in understanding the present invention. One with skill in the art will understand that numerous changes and variations can be made without departing from the spirit of the invention. Each of these changes and variations is within the scope of the present invention.

I claim:

1. A system for distribution of parcels comprising:
a system controller in communication over a network with at least one remote pod unit, said remote pod unit containing a plurality of lockable storage spaces;
a pod controller accepting one or more access codes to open a particular lockable storage space;
wherein said system is adapted to allow a shipper in possession one of said access codes to place a shipped parcel into said particular lockable storage space, and a recipient in possession of one of said access codes can remove said shipped parcel from the particular lockable storage space.

2. The system of claim 1 said access codes are obtainable on a web site.

3. The system of claim 1 wherein said system controller issues a notification to said recipient when shipper places the shipped parcel into the lockable storage space.

4. The system of claim 1 wherein at least one of said access codes is a contained in a bar code.

5. The system of claim 1 wherein said system controller controls a plurality of remote pod units.

6. The system of claim 1 wherein said lockable storage space contains a sensor sensing presence or absence of contents.

7. The system of claim 6 wherein said system controller is notified when said sensor detects a change in contents in said lockable storage space.

8. The system of claim 1 wherein a shipper can locally log into a particular pod unit and gain access to a plurality of lockable storage spaces for delivery to different recipients.

9. The system of claim 3 wherein said system controller controls a plurality of remote pod units.

10. The system of claim 9 wherein said lockable storage space contains a sensor sensing presence or absence of contents.

11. The system of claim 10 wherein said system controller is notified when a sensor in a particular lockable storage space detects a change in contents in said lockable storage space.

12. The system of claim 10 wherein said access code is transmitted to a cellular telephone.

13. A system for secure delivery of items from a sender to a receiver comprising:
a secure storage space accessed by at least one access code;
a system controller in communication with said secure storage space;
a website allowing said sender to obtain a sender access code to the secure storage space;
a contents sensor in said secure storage space, wherein said sensor is adapted to notify the system controller when contents change in said secure storage space;
the system controller adapted to notify said receiver that the sender has placed contents in said secure storage space and to provide the sender with a receiver access code to the secure storage space.

14. The system of claim 13 wherein the system controller is also adapted to notify the sender when contents are removed from said secure storage space.

15. The system of claim 13 wherein said access code is contained in a 2-dimensional bar code or QR code transmitted to a cellular telephone.

16. The system of claim 13 wherein the sender access code is different than the receiver access code.

17. The system of claim 16 wherein the sender access code cannot be reused.

18. A method for providing a secure transfer storage space between a sender and a receiver comprising:
providing a secure storage space for use by both a sender and a receiver;
providing a sender access code to said secure storage space to the sender;
providing a receiver access code to said secure storage space to either the receiver or the sender;
notifying the receiver when the sender places contents in said secure access space.

19. The method of claim 18 wherein said sender access code and said receiver access code is the same code.

20. The method of claim 18 wherein said receiver access code is contained in a 2-dimensional bar code or a QR code.
